(19) United States
(12) Patent Application Publication
(10) Pub. No.: US 2006/0187222 A1
(43) Pub. Date: Aug. 24, 2006

(54) Changing states of elements

(76) Inventor: Winthrop D. Childers, San Diego, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/064,317

(22) Filed: Feb. 23, 2005

(51) Int. Cl. G06T 15/50

(52) U.S. Cl. 345/426

(57) ABSTRACT

In embodiments, states of elements of a surface are changed.

### BACKGROUND

Projection systems are regarded as a cost effective way of providing very large array displays for a relatively low cost. Front projection, however, suffers from ambient light interference for all but the darkest rooms. For normal daytime ambient lighting, images looked “washed out” with ambient light. Another cost and efficiency issue is the desire for precise focusing optics. Precision focusing optics are generally expensive and tend to reduce the amount of available light, i.e., etendue.

### BRIEF DESCRIPTION OF THE DRAWINGS

FIG. 1 is a schematic of an embodiment of a projection system in accordance with one embodiment of the disclosure.

FIG. 2A is a schematic of an embodiment of a superpixel in accordance with one embodiment of the disclosure.

FIG. 2B is a schematic of the embodiment of the superpixel of FIG. 2A showing illumination of the superpixel in accordance with one embodiment of the disclosure.

FIGS. 3A and 3B are illustrations of two desired example images used in describing operation of a projection system in accordance with an embodiment of the disclosure.

FIG. 4A is a schematic of a superpixel for use in describing modulation of a light source and pixel element to produce the image of FIG. 3A in accordance with an embodiment of the disclosure.

FIG. 4B is a schematic of a superpixel for use in describing modulation of a light source and pixel element to produce the image of FIG. 3B in accordance with an embodiment of the disclosure.

FIG. 5 is a schematic of a projection system in accordance with a further embodiment of the disclosure.

FIG. 6 is a schematic of an image processing unit in accordance with another embodiment of the disclosure.

FIG. 7 is a schematic of a display screen and sensors for describing alignment and timing of light source and pixel element modulation in accordance with an embodiment of the disclosure.

### DETAILED DESCRIPTION

In the following detailed description of the present embodiments, reference is made to the accompanying drawings that form a part hereof, and in which is shown by way of illustration specific embodiments of the disclosure which may be practiced. These embodiments are described in sufficient detail to enable those skilled in the art to practice the subject matter of the disclosure, and it is to be understood that other embodiments may be utilized and that process, electrical or mechanical changes may be made without departing from the scope of the present disclosure. The following detailed description is, therefore, not to be taken in a limiting sense, and the scope of the present disclosure is defined by the appended claims and equivalents thereof.

An apparatus in accordance with one embodiment includes a light engine to project colored spots of light onto elements of a surface at a first resolution and a processing unit configured to cause the elements of the surface to change states at a second resolution higher than the first resolution. For the embodiments of the present disclosure, the viewing surface is of a type capable of varying its reflectivity (in the case of front projection systems) or transmissivity (in the case of rear projection systems) in a pixilated manner. For embodiments of the present disclosure, the light modulation function is split between the light engine and the viewing surface. Upon receiving an incoming video signal, the processing unit sends a first set of signals to control the light engine and a second set of signals to control the viewing surface.

In response to receiving the first set of signals, the light engine generates relatively large and lower resolution colored spots on the viewing surface. Resolution generally relates to a number of addressable elements to be used to create a display image, i.e., larger elements correspond to a lower resolution. As the number of addressable elements increases for a given size of image, its corresponding resolution is increased. These spots generally define the hue and the intensity of the video image to at least a first approximation for superpixels, or clusters of pixels. Thus we say that the light engine defines superpixels to a first approximation. In response to receiving the second set of signals, the viewing surface activates a higher resolution array of pixel elements that vary between a “black” state and a “white” state. These pixel elements define ON or OFF states for the individual pixels. In this way, they define edges and also provide gray levels via dithering patterns. By increasing a level of dithering, ambient light effects are reduced and color saturations may be increased. In this way, the light engine and the viewing surface modulate the light in a complementary manner.

Regardless of whether front projection or rear projection is used, some form of light engine is utilized to generate an image to be reflected from a viewing surface of a display, or transmitted through the viewing surface, respectively. One type of light engine utilizes a light source, a color wheel and a spatial modulator. Light generated from the light source is directed onto the color wheel, which sequentially filters light from the light source. The color wheel typically generates red light, green light and blue light. The red, green and blue light are sequentially sent to the spatial light modulator, which modulates the colored light depending on the desired image.

For such systems, maximum displayed intensity for a given pixel and color is determined by its modulation, i.e., an amount of time the spatial modulator allows projection of light during the total time the filter for that color is able to project light. As one example, a maximum intensity for red light could be achieved by allowing projection of light through the spatial modulator during the entire time the red filter is between the light source and the spatial modulator and a half intensity for red light could be achieved by allowing projection of light through the spatial modulator during half the time the red filter is between the light source and the spatial modulator and not permitting projection of light through the spatial modulator during the other half of the time the red filter is between the light source and the spatial modulator. It is noted that such light engines typically do not allow projection of light through the spatial modulator during the entire period for each color filter in order to facilitate better separation of colors by blocking projection of light during transition from one filter to the next.

Another type of light engine utilizes a light source and a color modulator. The color modulator separates incident light into a number of color light beams. Examples include digital light filters or a diffractive light device (DLD). Other systems may employ an array of light emitting diodes (LEDs), or lasers capable of scanning a series of spots across the viewing surface, as their light engine. In a similar manner, hue and intensity are generally controlled by modulating the amount of time light of a given hue is permitted to be projected on a given pixel. With any light engine, however, costs and complexity generally increase and etendue generally decreases as higher-resolution optics are employed to generate higher-resolution images.

Because the various embodiments facilitate use of light engines having a lower resolution than the desired viewable image, the viewing surface is modulated in coordination with the light projected from the light engine to produce the desired image. In other words, during projection of a given hue, the light engine may project light onto pixels of the viewing surface having a hue that is different from, or an intensity that is greater than, a desired value for those pixels. To produce the desired image on the viewing surface, the various embodiments coordinate the pixels of the viewing surface to reduce their intensity if the desired intensity is less, or to substantially block reflectance or transmission of light if that hue is not desired for that pixel.

The projection system may further include a pixel coordinate alignment function for permitting a proper degree of spatial alignment between the coordinates of each of the two light modulators. In one embodiment, a sensor system senses relative location between viewing surface pixels and the spots of light from the light engine. The coordinate alignment function may occur at various times, e.g., at startup or upon detection of shaking and/or periodically. The alignment function may further be invoked manually, e.g., by a user of the projection system, or automatically.

By allowing the light engine to define spots of light that are of lower resolution than the viewing surface, the use of precision focusing in the light engine may be reduced. This reduces the cost of the light modulator chip and the projection optics, and allows for more light to be transmitted to the viewing surface or, alternatively, allows for a lower-powered light source to be used. In addition, the actively addressable viewing surface facilitates increased contrast ratios in the presence of ambient light.

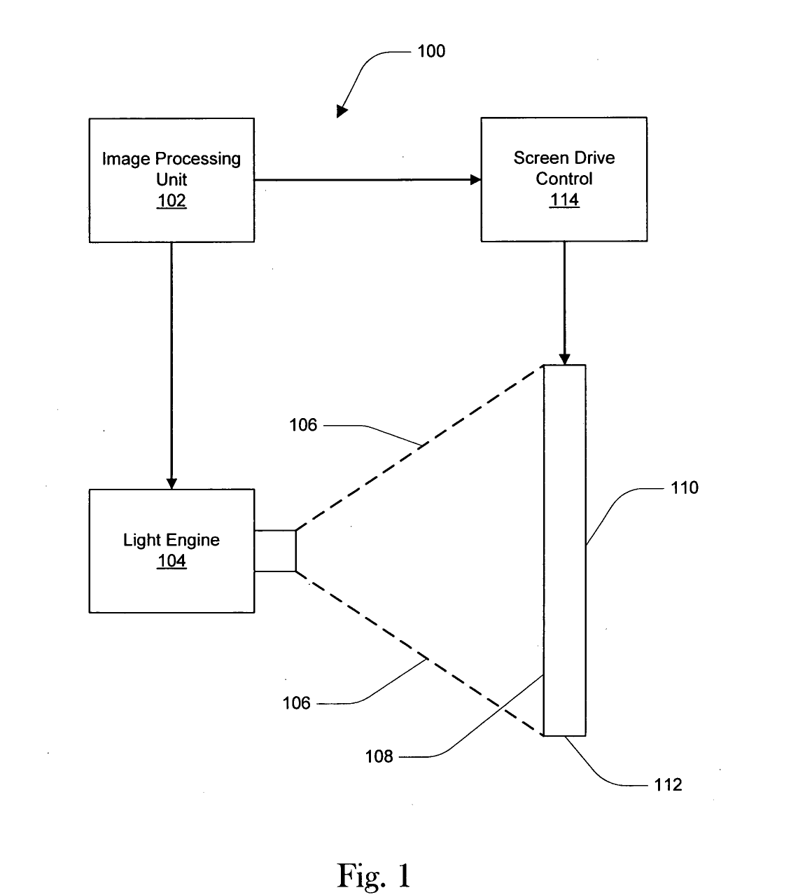

FIG. 1 is a schematic of a projection system 100 in accordance with one embodiment of the present disclosure. The projection system 100 includes an image processing unit 102 for control and coordination of the shared light modulation between the light engine 104 and the display screen 112. The image processing unit 102 receives incoming video signals and provide control signals for the light engine 104 and the screen drive control 114 for modulation of the screen 112.

The light engine 104 generally defines superpixels or colored spots of light, represented generally by dashed lines 106 projected onto surface 108 of screen 112. The spots of light 106 are in either a fixed matrix pattern or scan across the viewing surface and are modulated in response to control signals received from the image processing unit 102. For a front-projection system, an image is viewable as light reflected from the viewing surface 108 of screen 112. For a rear-projection system, an image is viewable as light transmitted through viewing surface 110 of screen 112.

The screen 112 includes an array of screen pixel elements (not shown in FIG. 1) that are controllable to be in an ON or white state (the highest degree of reflectivity that can generally be obtained for the embodiment of screen 112 used for front projection or the highest degree of transmissivity that can be obtained for the embodiment of screen 112 used for rear projection) or an OFF or black state (the highest degree of non-reflectivity that can be obtained for the embodiment of screen 112 used for front projection or the highest degree of non-transmissivity that can be obtained for the embodiment of screen 112 for rear projection). Screen drive control 114 controls the modulation of the pixel elements in response to control signals from the image processing unit 102. While the various embodiments are generally described in reference to the binary ON and OFF states of the elements for simplicity, it is noted that the various embodiments may also utilize elements capable of varying their states on a continuum between the ON and OFF states.

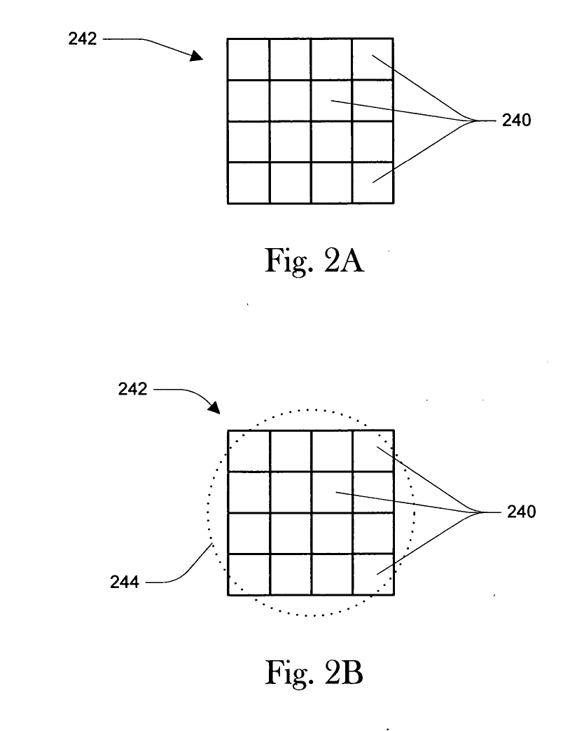

FIG. 2A is a schematic of a superpixel 242 in accordance with one embodiment of the present disclosure. As noted before, pixels are visible spots generated on the screen. The pixels are formed via a cooperative action of the light engine and screen pixel elements 240 and are the smallest unit of light modulation on screen 112 of this embodiment. Superpixels 242 contain a number of pixel elements 240. Although FIG. 2A depicts the superpixel 242 as a square containing a regular array of square pixel elements 240, other shapes and dimensions of pixel elements 240 may form a superpixel 242. A superpixel 242 may also portions or fractions of pixel elements 240.

The light projected onto the viewing surface by the light engine may correspond substantially to the shape and dimensions of the superpixel 242. However, the light may merely be a close approximation of the cluster of pixel elements 240. FIG. 2B is a schematic of the superpixel 242 of FIG. 2A showing illumination of the superpixel 242 in accordance with one embodiment of the present disclosure. In FIG. 2B a spot of light 244 may have a circular or other pattern illuminating outside the boundaries of the superpixel 242 in some areas while not fully illuminating all pixel elements 240 in other areas.

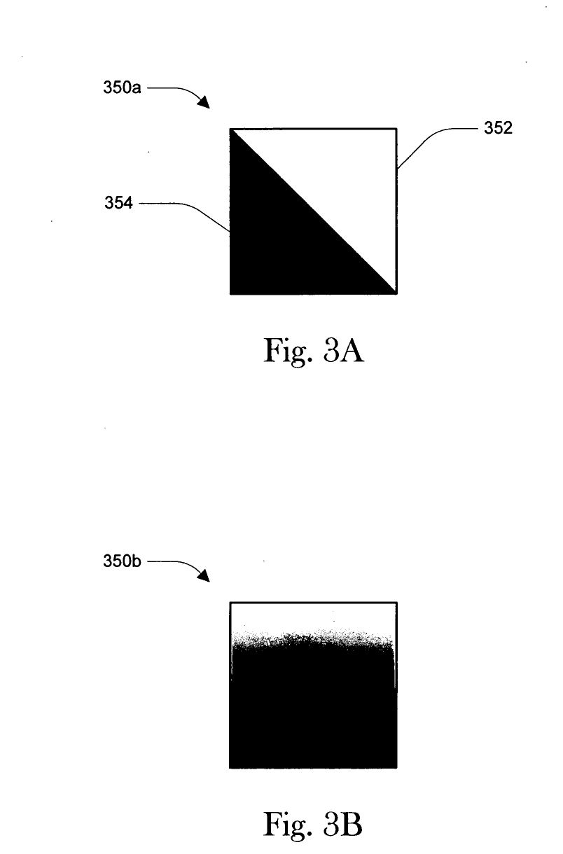

FIGS. 3A and 3B are illustrations of two desired example images 350a and 350b, respectively, used in describing operation of a projection system in accordance with an embodiment of the present disclosure. In FIG. 3A, a sharp interface is desired between a first color in portion 352 of desired image 350a and a second color in portion 354 of the desired image 350a. In FIG. 3B, a gradual transition between one color and another is depicted for desired image 350b. These two examples will be used to describe the cooperation between modulation of the light engine and the pixel elements. It will be apparent that other images can be formed using the concepts described below with reference to these two desired images. Furthermore, it is recognized that the creation of any displayed image is generally an approximation of the desired image consistent with the resolution of the display device.

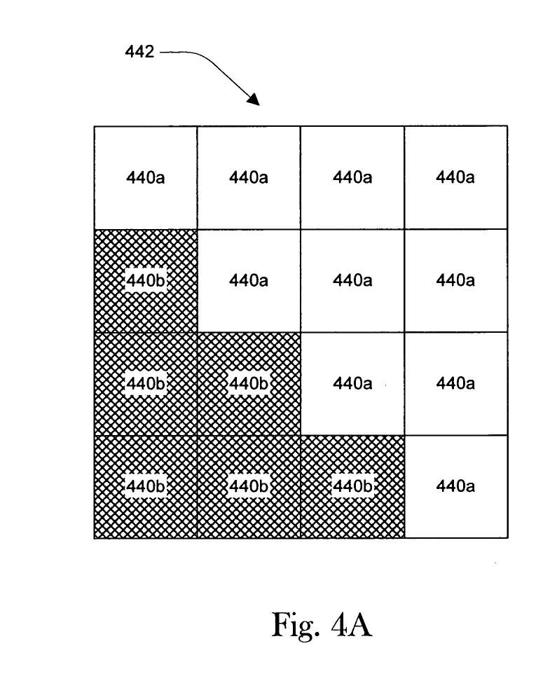

FIG. 4A is a schematic of a superpixel 442 for use in describing modulation of a light source and pixel elements 440 to produce the image 350a of FIG. 3A in accordance with an embodiment of the present disclosure. In a first case, the image 350a will be approximated assuming a black and white image. In a second case, the image 350a will be approximated assuming two projected colors, e.g., portion 352 of image 350a being red and portion 354 of image 350a being green.

In the first case of a black and white image, a first portion of pixel elements 440, i.e., pixel elements 440a, are in their ON state while a second portion of pixel elements 440, i.e., pixel elements 440b, are in their OFF state. For a light engine adapted to output red, green and blue light, for example, it would alternate projecting a red spot of light, a green spot of light and a blue spot of light on the superpixel 442 while pixel elements 440a remain in their ON state and pixel elements 440b remain in their OFF states. In this manner, the pixel elements 440a will be viewed as white while the pixel elements 440b will be viewed as black. The result is an image resolution that is much finer than the output resolution of the light engine.

In the second case of an image that appears to a viewer to be contemporaneously red and green, the pixel elements 440a and 440b will not remain in their respective ON and OFF states during the entire frame. For example, to view portion 352 of image 350a as red, a first portion of pixel elements 440, i.e., pixel elements 440a, are in their ON state and a second portion of pixel elements 440, i.e., pixel elements 440b, are in their OFF state during a red portion of a frame period, i.e., while a red light spot is being projected onto the superpixel 442. To view portion 354 of image 350a as green, the first portion of pixel elements 440, i.e., pixel elements 440a, are in their OFF state and the second portion of pixel elements 440, i.e., pixel elements 440b, are in their ON state during a green portion of the frame period, i.e., while a green light spot is being projected onto the superpixel 442. All pixel elements 440, i.e., 440a and 440b, would be in their OFF state during a blue portion of the frame period. In this manner, the pixel elements 440a will be viewed as red while the pixel elements 440b will be viewed as green.

FIG. 4B is a schematic of a superpixel 442 for use in describing modulation of a light source and pixel elements 440 to produce the image 350b of FIG. 3B in accordance with an embodiment of the present disclosure. In a first case, the image 350b will be approximated assuming a black and white image, e.g., transitioning from white at top to black at bottom. In a second case, the image 350b will be approximated assuming two projected colors, e.g., transitioning from red at top to green at bottom. It is noted that FIG. 4B is a conceptual representation of dithering utilized to give the appearance of a color transition.

In general, a combination of spatial and temporal dithering can be used. In spatial dithering, a number of pixel elements 440 in an ON state in a given row or column of pixel elements 440 controls the perceived brightness of that row or column of pixel elements 440. In temporal dithering, the perceived brightness of an individual pixel element 440 is controlled by an amount of time that pixel element 440 is in its ON state during projection of light.

Temporal dithering can be performed on a frame-by-frame basis or within a frame. Within a frame, we will refer to this as PWM (pulse width modulation). PWM can effectively reject ambient light if the screen pixel elements are fast enough. With PWM, sub-frames are defined and the PWM resolution is defined by the size of the minimum width sub-frame relative to the frame period. If PWM is not utilized, then spatial dithering may be used to boost the rejection while creating some dithering artifacts (checkerboard pattern) for lower resolution screens. However, these effects are reduced as resolution is increased. Furthermore, the spatial dithering pattern can be altered between frames, sometimes referred to as frame-to-frame bit flipping, to cancel out the dither artifacts. That is, one or more pixel elements that had been in an ON state during a first frame could be changed to an OFF state for a second frame, and/or one or more pixel elements that had been in an OFF state during the first frame could be changed to an ON state for the second frame.

In the first case of a white to black transition, a first portion of pixel elements 440, i.e., pixel elements 440a, are in their ON state while a second portion of pixel elements 440, i.e., pixel elements 440b, are in their OFF state during all or a portion of a frame. For a light engine adapted to output red, green and blue light, for example, it would alternate projecting a red spot of light, a green spot of light and a blue spot of light on the superpixel 442. For one embodiment, the pixel elements 440a and 440b would utilize the same spatial and/or temporal dithering during the red, green and blue portions of the frame. In this manner, the pixel elements 440a will be viewed as white while the pixel elements 440b will be viewed as black. The result is an image resolution that may be finer or much finer than the output resolution of the light engine. By utilizing dithering across or within frames, a perception of a white to black transition can be achieved.

In the second case of a red to green transition, a first portion of pixel elements 440, i.e., pixel elements 440a, are in their ON state while a second portion of pixel elements 440, i.e., pixel elements 440b, are in their OFF state during all or a portion of a red portion of a frame. In this manner, the superpixel 442 of FIG. 4B will appear more red at the top. Again, altering the spatial dither pattern between frames and/or utilizing temporal dithering facilitates a more gradual perceived transition from top to bottom. During a green portion of the frame, the pixel elements 440 would utilize a complementary pattern. For example, in one embodiment, if a pixel element 440 were in an ON state during the red portion of the frame, it would be in an OFF state during the green portion of the frame. In a further embodiment, if a pixel element 440 were in an ON state during X % of the red portion of the frame, it would be in an OFF state during X % of the green portion of the frame. In this manner, the superpixel 442 of FIG. 4B would appear more green at the bottom. The resulting image would approximate a transition from red at the top to green at the bottom.

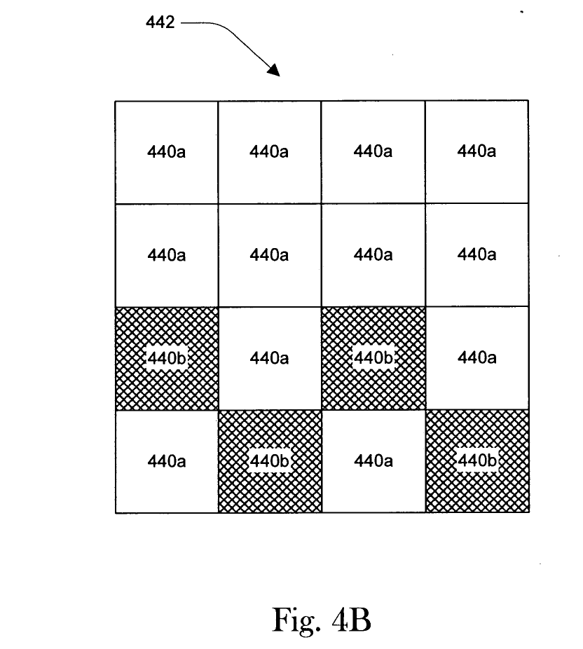

FIG. 5 is a schematic of a projection system 500 in accordance with a further embodiment of the present disclosure. Projection system 500 typically includes a light source or illumination source 520 configured to direct light along an optical path or light path toward screen 512. Light source 520 may be any suitable device configured to generate light and direct the light toward screen 512. For example, light source 520 may be a single light source, such as a mercury lamp or other broad-spectrum light source. Alternatively, light source 520 may include multiple light sources, such as light emitting diodes (LEDs), lasers, etc.

Light generated from light source 520 further may be directed onto a color modulator 522. Color modulator. 522 may be a spatial light modulator, such as a micromirror array, a color filter and/or a multi-colored light source. The color modulator 522 produces the relatively low-resolution color light array corresponding generally to the resolution of a superpixel. For one embodiment, the color modulator 522 is a DLD (diffraction light device) that modulates color on a superpixel basis. For the sake of example, consider a DLD having an array of 400×300 pixels (25% of the pixels of SVGA). The screen has a UXGA array of approximately 1600×1200 pixels that are each controllable to a black (OFF) or white (ON) state. The color modulator 522 generates color superpixels on the screen that are further modulated by the screen pixels to define features of the superpixels, such as edges, shading or colors for individual pixels. The color modulator 522 controls the average intensity and the hue for the superpixel for a given frame period or sub-frame.

For some embodiments, the color modulator 522 is integral with the light source 520. Alternatively, the color modulator 522 may be independent of the light source 520. Regardless of the configuration, the combination of a light source and a color modulator produces the color light array for projection of the superpixels.

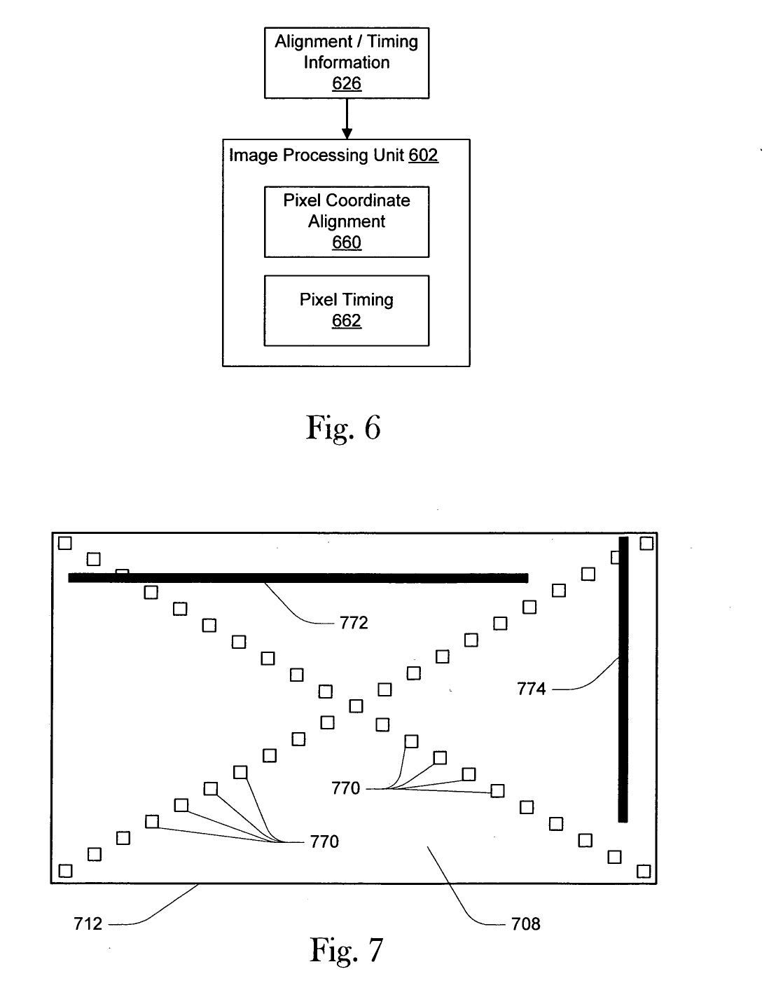

Projection system 500 may further include a modulator drive controller 518 configured to manage generation of the projected image from the light engine 504 in response to control signals from the image processing unit 502. Light, emitted from the light source 520 is modulated by color modulator 522, as directed by modulator drive control 518, and passed through projection optics 524 onto screen 512. Projection optics 524 may include one or more projection lenses. Typically, projection optics 524 are adapted to focus, size, and position the image on screen 512. Optionally, a motion detector 528, such as an accelerometer, may be included to detect movement of the light engine 504. When movement is detected, alignment of the projection system could be invoked automatically to maintain appropriate alignment between the light engine 504 and the screen 512. Alignment of the projection system is described with reference to FIG. 7 herein.

In operation, image data 516 for a desired image is received by the image processing unit 502. The image processing unit 502 generates control signals for use by the light engine 504 and screen drive control 514 such that the light engine 504 will be directed to project the appropriate spots of light and the modulated screen 512 will be directed to correspondingly modulate its pixel elements, such as was described with reference to FIGS. 3A-3B and 4A-4B, to approximate the desired image on the screen 512. The modulated screen 512 provides an ON or OFF state on a per pixel basis. When a given pixel element is ON, then the surface of the associated pixel is reflective as explained previously, in the case of a front-projection system, or transmissive as explained previously, in the case of a rear-projection system. When a given pixel element is OFF, then the surface of the associated pixel is black or non-reflective as explained previously, in the case of a front-projection system, or opaque or non-transmissive as explained previously, in the case of a rear-projection system. The screen 512 is utilized to define black regions, sharp boundaries between two color states, or shading using dither patterns.

It will be recognized that reasonable alignment of a projected spot of light and its corresponding pixel elements is useful to accomplish the shared light modulation between the light engine 504 and the screen 512. Accordingly, manual or automated alignment information 526 is provided to image processing unit 502 to facilitate such alignment of the projected light and its corresponding pixel elements. The alignment information 526 represents some indication, described in more detail below, to permit the image processing unit 502 to determine which pixel elements of screen 512 correspond to a given spot of light from the light engine 504. For one embodiment, the alignment information 526 is derived from sensors embedded within screen 512 responsive to light coming from the light engine 504. For another embodiment, the alignment information 526 is derived from a CCD device. CMOS device or other light-sensitive sensor responsive to the image perceived on screen 512.

While the various functionality of the projection system 500 is depicted as corresponding to discrete control entities, it is recognized that much of the functionality can be combined in a typical electronic circuit or even an application-specific integrated circuit chip in various embodiments. For example, the functionality of the image processing unit 502 and the screen drive control 514 could be contained within the light engine 504, with the light engine 504 directly receiving the image data 516 and providing a control output to the screen 512. Alternatively, the screen drive control 514 could be a component of the screen 512.

It is noted that the image processing unit 502 may be adapted to perform the methods in accordance with the various embodiments in response to computer-readable instructions. These computer-readable instructions may be stored on a computer-usable media 530 and may be in the form of either software, firmware or hardware. In a hardware solution, the instructions are hard coded as part of a processor, e.g., an application-specific integrated circuit chip. In a software or firmware solution, the instructions are stored for retrieval by the processor. Some additional examples of computer-usable media include read-only memory (ROM), electrically-erasable programmable ROM (EEPROM), flash memory, magnetic media and optical media, whether permanent or removable.

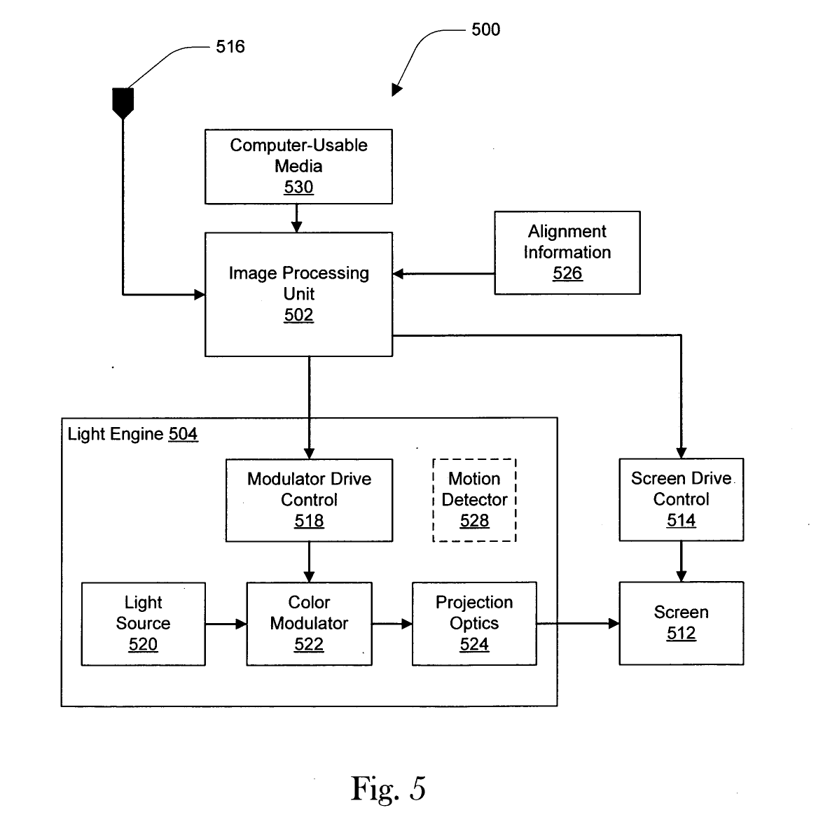

FIG. 6 is a schematic of an image processing unit 602 in accordance with another embodiment of the present disclosure. The image processing unit 602 includes a pixel coordinate alignment function 660 for facilitating proper spatial alignment between the coordinates of each of the two light modulators, i.e., the light engine and the screen, in response to alignment/timing information 626. In one embodiment, a sensor system senses relative location between viewing surface pixels and the spots of light from the light engine. In another embodiment, a perceived image from the screen is detected by a CCD device, CMOS device or other light-sensitive sensor and compared to an expected image to determine the relative location between viewing surface pixels and the spots of light from the light engine. The pixel coordinate alignment function 660 may be invoked at various times, e.g., at startup or upon detection of shaking and/or periodically. The alignment function may further be invoked manually, e.g., by a user of the projection system, or automatically.

The image processing unit 602 further includes a pixel coordinate timing function 662 to facilitate accurate synchronization between light signals from the light engine and the viewing surface pixel elements in response to alignment/timing information 626. If the screen and the light engine share the same frame buffer, this system timing function may simply be sending the buffered information to the light modulators (screen and light engine) at the same time. In one embodiment, a sensor system senses relative timing between viewing surface pixels and the spots of light from the light engine. In another embodiment, a perceived image from the screen is detected by a CCD device, CMOS device or other light-sensitive sensor and compared to an expected image to determine the relative timing between viewing surface pixels and the spots of light from the light engine. The pixel coordinate timing function 662 may be invoked at various times, e.g., at startup or upon detection of flicker and/or periodically. The alignment function may further be invoked manually, e.g., by a user of the projection system, or automatically.

FIG. 7 is a view of a display screen 712, normal to its viewing surface 708, and sensors 770 for describing alignment and timing of light source and pixel element modulation in accordance with an embodiment of the present disclosure. The sensors 770 may be embedded within the screen 712 to detect incident light. Alternatively, the sensors 770 may represent a CCD device, CMOS device or other light-sensitive sensors, external to screen 712, for detecting light reflected from or transmitted from the viewing surface 708. Such external sensors could be a component of the light engine.

While the sensors 770 are depicted to be in a crossed pattern, other patterns may be utilized consistent with the disclosure. Furthermore, while substantially all of the viewing surface 708 is encompassed by the sensors 770, in some embodiments this may not be the case. In the extreme case, one sensor 770 could be utilized to detect a horizontal and/or vertical position of a projected spot of light. Two sensors 770 would allow for determining rotation issues. However, the inclusion of additional sensors allows for ease of determining the location of a projected image and an accuracy of any adjustments.

As one example, vertical alignment can be determined by projecting a horizontal stripe 772, such as multiple adjacent spots of light or a scan of a single spot of light, on the viewing surface 708. Based on where the horizontal stripe 772 is detected by sensors 770, its location relative to the viewing surface 708 may be determined. Detection of the horizontal stripe 772 by two or more sensors can provide a degree of rotation of the horizontal stripe 772. If the horizontal stripe 772 is not detected in its expected location and rotation, the pixel coordinate alignment function 660 of the image processing unit 602 can make appropriate corrections such that the horizontal stripe 772 will be projected in its expected location. For sensors 770 embedded in the viewing surface 708, the pixel elements may not be modulated as the sensors are dependent upon incident light, and its absorption, reflection or transmission is immaterial. For external sensors 770, the pixel elements should be in the ON state such that the horizontal stripe 772 is capable of being perceived by the sensors.

In a similar manner, horizontal alignment can be determined by projecting a vertical stripe 774, such as multiple adjacent spots of light or a scan of a single spot of light, on the viewing surface 708. Based on where the vertical stripe 774 is detected by sensors 770, its location relative to the viewing surface 708 may be determined. Detection of the vertical stripe 774 by two or more sensors can provide a degree of rotation of the vertical stripe 774. If the vertical stripe 774 is not detected in its expected location and rotation, the pixel coordinate alignment function 660 of the image processing unit 602 can make appropriate corrections such that the vertical stripe 774 will be projected in its expected location.

As another example, for external sensors 770, horizontal stripes 772 and vertical stripes 774 are projected and scanned across an active screen 712. By placing limited rows of pixel elements in the ON state, individual horizontal stripes 772 will be perceived when crossing a row of pixel elements in the ON state. By placing limited columns of pixel elements in the ON state, individual vertical stripes 774 will be perceived when crossing a column of pixel elements in the ON state. Timing of when a horizontal stripe 772 or vertical stripe 774 is perceived provides information regarding which projected horizontal stripe 772 or vertical stripe 774 aligns with the active pixel elements, thus providing alignment information. While examples have been provided for determining and correcting alignment, the subject matter of the present disclosure is not limited to any particular alignment technique. For example, alignment information could be generated in response to generating other detectable edges such as circles or other patterns.

Regardless of how alignment is determined, alignment allows a lookup table to be generated or a coordinate shift to be defined that defines a location for each illuminated screen pixel element and each color superpixel element in relation to positions in the image to be displayed. In this manner, a cluster of screen pixel elements can be associated with an individual superpixel such that a superpixel and its corresponding pixel elements can function cooperatively as described above. Alternatively, projection of individual superpixels can be adjusted to fall on a desired cluster of screen pixel elements such that, again, a superpixel and its corresponding pixel elements can function cooperatively as described above.

For embodiments where the screen and the light engine do not share the same frame buffer, timing adjustments can be made using the same sensors 770 used for alignment detection. As an example, a periodic projection of light, e.g., a horizontal stripe 772, vertical stripe 774, a spot of light or entire illumination of the viewing surface 708, can be detected by embedded sensors 770 and used to align the timing of the light engine and screen 708. Similarly, for external sensors 770, periodically cycling the pixel elements between the ON state and OFF state with a steady illumination of the viewing surface can be detected by the external sensors 770 and used to align the timing of the light engine and screen 708.

What is claimed is:

1. An apparatus, comprising:
a light engine to project colored spots of light onto elements of a surface at a first resolution; and
a processing unit configured to cause the elements to change states at a second resolution higher than the first resolution.

2. The apparatus of claim 1, wherein the surface is an actively-addressable viewing surface.

3. The apparatus of claim 2, wherein the processing unit is further adapted to modulate light projected from the light engine to the first resolution, to modulate the elements of the actively-addressable viewing surface to a second resolution higher than the first resolution and to coordinate the light modulation between the light engine and the actively-addressable viewing surface to project an image on the viewing surface.

4. The apparatus of claim 1, wherein the processing unit is configured to cause the elements to change between ON and OFF states.

5. The apparatus of claim 4, wherein the processing unit is configured to cause the elements to vary their states on a continuum between the ON and OFF states.

6. The apparatus of claim 1, wherein the processing unit is further adapted to modulate the elements of the surface on a per pixel basis and to modulate the light engine to project the colored spots of light encompassing multiple pixels.

7. The apparatus of claim 1, wherein:
the processing unit is further adapted to provide first control signals to the light engine to modulate individual spots of light during a frame and to provide second control signals to a drive control of the surface to modulate the elements of the surface between ON and OFF states during the frame;
different colored spots of light are configured to be projected on a given set of elements of the surface at different times during the frame; and
the second control signals are adapted to modulate the given set of elements of the surface to permit different states during the different portions of the frame dependent upon a desired perceived image to be displayed on the surface.

8. The apparatus of claim 1, wherein:
the processing unit is further adapted to provide first control signals to the light engine to project a first color spot of light during a first subframe and to project a second color spot of light during a second subframe and to provide second control signals to a drive control of the surface to modulate a plurality of elements of the surface illuminated by the first color spot of light and the second color spot of light;
the second control signals are adapted to place a portion of the plurality of elements of the surface in an ON state during the first subframe if the first color spot of light is desired to be viewed from that portion of the plurality of elements of the surface during the first subframe and to place a remaining portion of the plurality of elements of the surface in an OFF state during the first subframe if the first color spot of light is not desired to be viewed from that remaining portion of the plurality of elements of the surface during the first subframe; and
the second control signals are adapted to place a portion of the plurality of elements of the surface in an ON state during the second subframe if the second color spot of light is desired to be viewed from that portion of the plurality of elements of the surface during the second subframe and to place a remaining portion of the plurality of elements of the surface in an OFF state during the second subframe if the second color spot of light is not desired to be viewed from that remaining portion of the plurality of elements of the surface during the second subframe.

9. The apparatus of claim 1, wherein:
the processing unit is further adapted to provide first control signals to the light engine to project a first color spot of light during a first subframe and to project a second color spot of light during a second subframe and to provide second control signals to a drive control of the surface to modulate a plurality of elements of the surface illuminated by the first color spot of light and the second color spot of light;
the second control signals are adapted to modulate the plurality of elements of the surface between an ON state and an OFF state during the first subframe responsive to a desired intensity of the first color spot of light during the first subframe; and
the second control signals are adapted to modulate the plurality of elements of the surface between an ON state and an OFF state during the second subframe responsive to a desired intensity of the second color spot of light during the first subframe.

10. The apparatus of claim 1, wherein the processing unit is further adapted to receive alignment information to adjust an alignment of light projected from the light engine.

11. The apparatus of claim 10, wherein adjusting an alignment of light projected from the light engine further comprises associating a cluster of elements of the surface with an individual spot of light projected by the light engine or adjusting projection of individual spots of light to fall on a desired cluster of elements of the surface.

12. The apparatus of claim 10, wherein the processing unit is further adapted to adjust an alignment of the light projected from the light engine automatically and/or in response to a user input.

13. The apparatus of claim 10, wherein the processing unit is further adapted to adjust an alignment of the light projected from the light engine in response to an event selected from the group consisting of start-up of the apparatus, detection of movement of the light engine and passing of a predetermined duration of time.

14. The apparatus of claim 1, wherein the processing unit is further adapted to receive timing information to adjust a timing of light projected from the light engine.

15. The apparatus of claim 1, wherein the light engine further comprises a motion detector.

16. The apparatus of claim 15, wherein the processing unit is further adapted to adjust an alignment of light projected from the light engine in response to detecting movement of the light engine by the motion detector.

17. The apparatus of claim 1, further comprising the surface.

18. A projection system, comprising:
a light engine for projecting light forming color superpixels at a first resolution;
a viewing surface having screen elements at a second resolution greater than the first resolution; and
an image processing unit to cause states of the screen elements to change based upon the projected superpixels.

19. The projection system of claim 18, wherein the image processing unit is further adapted to define a cooperative operative association between the light engine and the viewing surface.

20. The projection system of claim 18, wherein each superpixel corresponds to a cluster comprising multiple screen elements.

21. The projection system of claim 20, wherein each cluster of screen elements is a regular array of screen elements.

22. The projection system of claim 20, wherein each superpixel has substantially the same shape and dimensions as its corresponding cluster of screen elements.

23. The projection system of claim 20, wherein each superpixel is capable of illuminating at least a portion of each screen element within its corresponding cluster of screen elements.

24. The projection system of claim 18, further comprising:
means for adjusting an alignment of the superpixels with a corresponding cluster of screen elements;
wherein the means for adjusting an alignment of the superpixels with a corresponding cluster of screen elements is adapted to associate a cluster of screen elements with an individual superpixel or adjust projection of individual superpixels to fall on a desired cluster of screen elements.

25. The projection system of claim 20, wherein:
the image processing unit is further adapted to provide first control signals to the light engine to modulate individual color superpixels during a frame and to provide second control signals to a drive control of the viewing surface to modulate the corresponding cluster of screen elements between ON and OFF states during the frame;
different colored superpixels are configured to be projected on a given cluster of screen elements at different times during the frame; and
the second control signals are adapted to modulate the given cluster of screen elements to permit different states during the different portions of the frame dependent upon a desired perceived image to be displayed on the viewing surface.

26. A method, comprising:
generating light spots of more than one color on elements of a viewing surface; and
changing states of the elements to define features of the light spots;
wherein the light spots have a resolution lower than the elements.

27. The method of claim 26, wherein generating light spots on elements of the viewing surface further comprises modulating a light source for both hue and intensity.

28. The method of claim 26, wherein changing states of the elements further comprises changing a reflectivity or transmissivity of the elements.

29. The method of claim 26, further comprising:
aligning the light spots with a corresponding set of elements.

30. The method of claim 29, wherein aligning the light spots with a corresponding set of elements further comprises generating a lookup table or a coordinate shift to associate each light spot with a corresponding set of elements that can be illuminated by that light spot.

31. The method of claim 29, wherein aligning the light spots with a corresponding set of elements further comprises adjusting projection of the light spots to illuminate their corresponding set of elements.

32. The method of claim 29, wherein aligning the light spots further comprises:
projecting a detectable edge on the viewing surface;
detecting a location of the detectable edge, thereby generating alignment information; and
receiving the alignment information by the projection system.

33. The method of claim 32, wherein detecting the location of the detectable edge further comprises detecting the location of the detectable edge using embedded sensors of the viewing surface.

34. The method of claim 32, wherein detecting the location of the detectable edge further comprises detecting the location of the detectable edge using sensors external to the viewing surface.

35. The method of claim 29, wherein aligning the light spots further comprises:
projecting a series of horizontal stripes on the viewing surface;
placing a row of the elements in an ON state during the projecting of the series of horizontal stripes;
detecting when a horizontal stripe aligns with the row of the elements in the ON state, thereby generating alignment information; and
receiving the alignment information by the projection system.

36. The method of claim 35, wherein aligning the light spots further comprises:
projecting a series of vertical stripes on the viewing surface;
placing a column of the elements in an ON state during the projecting of the series of vertical stripes;
detecting when a vertical stripe aligns with the column of the elements in the ON state, thereby generating alignment information; and
receiving the alignment information by the projection system.

37. The method of claim 26, further comprising:
adjusting a timing of the light spots with a modulation of a corresponding set of elements.

38. The method of claim 37, wherein adjusting the timing further comprises:
periodically illuminating at least a portion of the viewing surface;
detecting a timing of the periodic illumination of the viewing surface, thereby generating timing information; and
receiving the timing information by the projection system.

39. The method of claim 37, wherein adjusting the timing further comprises:
periodically switching elements of the viewing surface from and ON state to an OFF state;
detecting a timing of the periodic switching of the elements, thereby generating timing information; and
receiving the timing information by the projection system.

40. The method of claim 26, further comprising:
modulating individual light spots during a frame and modulating a corresponding cluster of elements of the viewing surface between ON and OFF states during the frame;
wherein different colored light spots are configured to be projected on a given cluster of elements at different times during the frame; and
wherein the second control signals are adapted to modulate the given cluster of elements to permit different states during the different portions of the frame dependent upon a desired perceived image to be displayed on the viewing surface.

41. The method of claim 26, further comprising:
projecting a light spot having a first color during a first subframe and projecting a light spot having a second color during a second subframe and modulating a plurality of elements of the viewing surface illuminated by the first color light spot and the second color light spot;
placing a portion of the plurality of elements in an ON state during the first subframe if the first color light spot is desired to be viewed from that portion of the plurality of elements during the first subframe and placing a remaining portion of the plurality of elements in an OFF state during the first subframe if the first color light spot is not desired to be viewed from that remaining portion of the plurality of elements during the first subframe; and
placing a portion of the plurality of elements in an ON state during the second subframe if the second color light spot is desired to be viewed from that portion of the plurality of elements during the second subframe and placing a remaining portion of the plurality of elements in an OFF state during the second subframe if the second color light spot is not desired to be viewed from that remaining portion of the plurality of elements during the second subframe.

42. The method of claim 26, further comprising:
projecting a light spot having a first color during a first subframe and projecting a light spot having a second color during a second subframe and modulating a plurality of elements of the viewing surface illuminated by the first color light spot and the second color light spot in coordination with projecting the first color light spot and the second color light spot;
modulating the plurality of elements between an ON state and an OFF state during the first subframe responsive to a desired intensity of the first color light spot during the first subframe; and
modulating the plurality of elements between an ON state and an OFF state during the second subframe responsive to a desired intensity of the second color light spot during the first subframe.

43. An apparatus, comprising:
means for generating light spots of different colors on a viewing surface, the light spots having a first resolution;
means for changing states of elements of the viewing surface, the elements having a second resolution higher than the first resolution; and
means for coordinating the means for generating light spots and means for changing states of elements of the viewing surface to display a projected image at the second resolution.

44. The apparatus of claim 43, wherein the means for generating light spots of different colors further comprises means for modulating an intensity and hue of the light spots.

45. The apparatus of claim 43, wherein the means for changing states of elements of the viewing surface further comprises means for adjusting a reflectance or transmissivity of the elements.

46. The apparatus of claim 43, wherein the means for coordinating further comprises means for adjusting a timing and/or alignment of the light spots.

47. The apparatus of claim 46, wherein the means for adjusting a timing and/or alignment of the light spots further comprises means for detecting light reflected from or transmitted through the viewing surface.

48. A computer-usable media having computer-readable instructions adapted to cause a processor to perform a method, the method comprising:
receiving image data;
generating first control signals in response to the image data for generating light spots of different colors having a first resolution;
generating second control signals in response to the image data for changing states of elements of a viewing surface, the elements having a second resolution higher than the first resolution.

49. The computer-usable media of claim 48, wherein the method further comprises:
coordinating the first control signals and the second control signals to facilitate generating an image at the second resolution when the light spots having the first resolution are projected onto the elements of the viewing surface.

50. The computer-usable media of claim 48, wherein the method further comprises:
receiving timing information for adjusting a timing of the light spots in relation to the changing states of the elements of the viewing surface.

51. A method, comprising:
a step for modulating a light source for defining a hue and an intensity of one or more light spots having a first resolution;
a step for combining the one or more light spots as a superpixel illuminating a cluster of elements of a viewing surface; and
a step for modulating the cluster of elements of the viewing surface for defining features of the superpixel at a second resolution higher than the first resolution.
